(19) United States
(12) Patent Application Publication
(10) Pub. No.: US 2025/0356841 A1
(43) Pub. Date: Nov. 20, 2025

(54) SPEECH SYNTHESIS

(71) Applicants: Beijing Zitiao Network Technology Co., Ltd., Beijing (CN); Lemon Inc., Grand Cayman (KY)

(72) Inventors: Jiawei Chen, Beijing (CN); Yuanzhe Chen, Beijing (CN); Dongya Jia, Beijing (CN); Zhengxi Liu, Beijing (CN); Jian Cong, Beijing (CN); Chumin Li, Beijing (CN); Xin Wang, Beijing (CN); Lin Liu, Beijing (CN); Zhuo Chen, Los Angeles, CA (US); Yuping Wang, Beijing (CN); Yuxuan Wang, Los Angeles, CA (US)

(21) Appl. No.: 19/207,299

(22) Filed: May 13, 2025

(30) Foreign Application Priority Data
May 14, 2024 (CN) 202410599678.X

(51) Int. Cl. G10L 13/047; G10L 13/027; G10L 13/033

(52) U.S. Cl. CPC G10L 13/047; G10L 13/027; G10L 13/033

(57) ABSTRACT

Embodiments of the disclosure relate to speech synthesis. A method provided herein includes: constructing, based on target text and prompt speech content, an input sequence corresponding to a sequence template, wherein the sequence template includes a placeholder, and a sequence segment, in the input sequence, corresponding to the placeholder is: preset content independent of the prompt speech content, or a speech feature representation generated based on the prompt speech content; and processing the input sequence with a target model to generate target speech content corresponding to the target text, wherein the target model is trained with a set of training sequences constructed based on the sequence template, the set of training sequences corresponds to a set of training speech content, and the set of training sequences is constructed by replacing the placeholder with the preset content or a training speech feature representation corresponding to respective training speech content.

### CROSS-REFERENCE

The present application claims priority to Chinese Patent Application No. 202410599678.X, filed on May 14, 2024, and entitled “SPEECH SYNTHESIS METHOD, APPARATUS, DEVICE AND MEDIUM”, the entirety of which is incorporated herein by reference.

### FIELD

Example embodiments in the present disclosure generally relate to the field of computer technologies, and in particularly to speech synthesis.

### BACKGROUND

At present, the speech generation technology may generate new speech based on a reference speech, and this technique mainly extracts speech features from the reference speech with a machine learning model, and then generates new speech in combination with target text. The new generated speech may have a similar style to the target object. This technology may be applied to scenarios such as voice assistants, virtual characters and educational software, so as to realize personalized speech interaction and experience.

### SUMMARY

In a first aspect of the present disclosure, a speech synthesis method is provided. The method includes: constructing, based on target text and prompt speech content, an input sequence corresponding to a sequence template, wherein the sequence template comprises a placeholder, and a sequence segment, in the input sequence, corresponding to the placeholder is: preset content independent of the prompt speech content, or a speech feature representation generated based on the prompt speech content; and processing the input sequence with a target model to generate target speech content corresponding to the target text, wherein the target model is trained with a set of training sequences constructed based on the sequence template, the set of training sequences corresponds to a set of training speech content, and the set of training sequences is constructed by replacing the placeholder with the preset content or a training speech feature representation corresponding to respective training speech content.

In a second aspect of the present disclosure, an apparatus for speech synthesis is provided. The apparatus includes: an input sequence construction module, configured to construct, based on target text and prompt speech content, an input sequence corresponding to a sequence template, wherein the sequence template comprises a placeholder, and a sequence segment, in the input sequence, corresponding to the placeholder is: preset content independent of the prompt speech content, or a speech feature representation generated based on the prompt speech content; and a target speech content generation module, configured to process the input sequence with a target model to generate target speech content corresponding to the target text, wherein the target model is trained with a set of training sequences constructed based on the sequence template, the set of training sequences corresponds to a set of training speech content, and the set of training sequences is constructed by replacing the placeholder with the preset content or a training speech feature representation corresponding to respective training speech content.

In a third aspect of the present disclosure, an electronic device is provided. The device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium has a computer program stored thereon, wherein the computer program is executable by a processor to perform the method of the first aspect.

It should be understood that the summary described in this disclosure is not intended to limit key features or important features of embodiments in the present disclosure, nor is it intended to limit the scope in the present disclosure. Other features in the present disclosure will become readily understood from the following description.

### BRIEF DESCRIPTION OF DRAWINGS

The above and other features, advantages, and aspects of the various embodiments in the present disclosure will become more apparent from the following detailed description taken in combination with the accompanying drawings. In the drawings, the same or similar reference numbers refer to the same or similar elements, where:

FIG. 1 illustrates a schematic diagram of an example environment in which embodiments according to the present disclosure may be implemented;

FIG. 2 illustrates a schematic diagram of constructing a training sequence according to some embodiments of the present disclosure;

FIGS. 3A and 3B illustrate schematic diagrams of constructing an input sequence according to some embodiments of the present disclosure;

FIG. 4 illustrates a flowchart of an example process of speech synthesis according to some embodiments of the present disclosure;

FIG. 5 illustrates a schematic structural block diagram of an example apparatus for speech synthesis according to some embodiments of the present disclosure; and

FIG. 6 illustrates a block diagram of an electronic device capable of implementing various embodiments of the present disclosure.

### DETAILED DESCRIPTION

The embodiments in the present disclosure will be described in more detail below with reference to the accompanying drawings. Although certain embodiments in the present disclosure are shown in the drawings, it would be appreciated that the present disclosure can be implemented in various forms and should not be interpreted as limited to the embodiments described in this specification. On the contrary, these embodiments are provided for a more thorough and complete understanding in the present disclosure. It would be appreciated that the accompanying drawings and embodiments in the present disclosure are only for the purpose of illustration and are not intended to limit the scope of protection in the present disclosure.

It should be noted that the headline of any section/subsection provided in the specification is not limiting. Various embodiments are described throughout the specification and any type of embodiments may be included in any section/subsection. Furthermore, the embodiments described in any section/subsection may be combined in any manner with any other embodiment described in the same section/subsection and/or different sections/subsections.

In the description of the embodiments in the present disclosure, the term “including” and similar terms would be appreciated as open-ended inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. The terms “first”, “second” and the like may refer to different or the same objects. Other explicit and implicit definitions may also be included below.

The embodiments in the present disclosure may relate to user data, acquisition and/or use of data, and the like. These aspects shall comply with the requirements of corresponding laws, regulations and relevant provisions. In the embodiments in the present disclosure, the collection, acquisition, processing, manufacturing, forwarding, use of all data and the like are carried out with user's knowledge and consent. Accordingly, in the implementation of the embodiments in the present disclosure, users should be informed of the type, the scope of use, the use scenario, etc., of the involved data or information in an appropriate manner and provide authorization in accordance with relevant laws and regulations. The specific ways of being informed and providing authorization may vary according to actual circumstances and application scenarios, and the scope of this disclosure is not limited in this regard.

In the solutions and embodiments in this disclosure, if personal information processing is involved, it will be carried out based on legitimate grounds (such as obtaining consent from the data subject, or as required to fulfill a contract, etc.) and will be performed only within a specified or agreed scope. If users decline the processing of personal information beyond what is essential for basic functionalities, their utilization of these basic features remains uninterrupted.

As briefly described above, the speech feature may be extracted from the reference speech with the machine learning model, and then the new speech may be generated in combination with the target text. The reference speech may be speech utter by the target object, for example, the reference speech may be various forms of audio data such as a recording, a phone call, and a meeting minute of the target object. The reference speech may include various speech features (e.g., timbre, tone, and the like) of the sound of the target object, which results in the new speech generated based on the reference speech may have some undesired features, such as accent and the like. It should be understood that the data (e.g., reference speech, including but not limited to data itself, acquisition and use of data, etc.) involved in the present disclosure should comply with the requirements of corresponding laws, regulations and relevant provisions.

Therefore, the embodiments in the present disclosure provide a speech synthesis method, including: constructing, based on target text and prompt speech content, an input sequence corresponding to a sequence template, wherein the sequence template comprises a placeholder, and a sequence segment, in the input sequence, corresponding to the placeholder is: preset content independent of the prompt speech content, or a speech feature representation generated based on the prompt speech content; and processing the input sequence with a target model to generate target speech content corresponding to the target text, where the target model is trained with a set of training sequences constructed based on the sequence template, the set of training sequences corresponds to a set of training speech content, and the set of training sequences is constructed by replacing the placeholder with the preset content or a training speech feature representation corresponding to respective training speech content.

As will be more clearly understood from the following description, the embodiments of the present disclosure may construct the input sequence based on the prompt speech through a placeholder, and the target speech with a style similar to the prompt speech content may be generated based on such input sequence. In addition, the placeholder may also construct the input sequence based on the speech feature representation, and the target speech with a style similar to the speech feature representation may be generated based on such input sequence, which may filter out undesired speech features. In this way, the target voice may be finely adjusted, thereby realizing more detailed personalized customization.

It should be understood that the use of the speech attributes (e.g., timbre and the like) mentioned in this disclosure is conducted with the knowledge and authorization of the corresponding speaker.

Various example implementations of this solution will be described in detail below with reference to the accompanying drawings.

### Example Environment

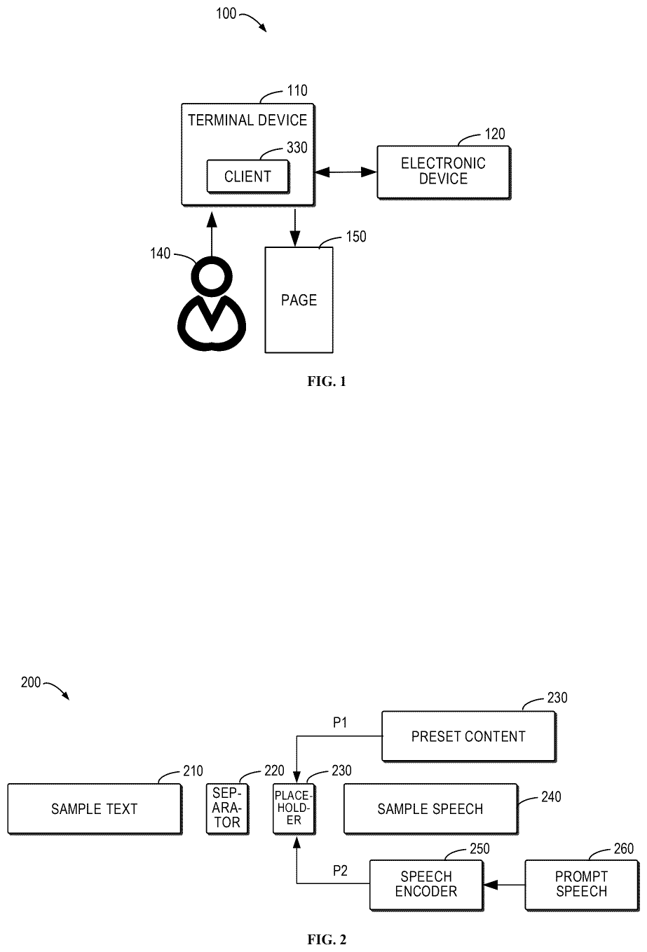

FIG. 1 illustrates a schematic diagram of an example environment 100 in which embodiments of the present disclosure may be implemented. As shown in FIG. 1, the example environment 100 may include a terminal device 110 and an electronic device 120.

In the example environment 100, a client 130 for interacting with the electronic device 120 is installed in the terminal device 110. A user 140 may interact with the client 130 via the terminal device 110 and/or its attached device. The client 130 may be a social application, a content sharing application, or any other suitable application.

In the environment 100 of FIG. 1, if the client 130 is in an active state, the client 130 may provide services such as creation or playback of media content for the user 140.

In addition, the terminal device 110 may present an interface 150 of the client 130. According to the specific service provided, the interaction behavior/preset operation of the user and the like, the content presented by the interface 150 may also change.

In some embodiments, the terminal device 110 communicates with the electronic device 120 to realize the provision of services of the client 130. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 may also support any type of interface for the user (such as a “wearable” circuit, etc.).

The electronic device 120 may be a standalone physical server, a server cluster or distributed system composed of multiple physical servers, or may be a cloud server providing basic cloud computing services such as cloud services, cloud databases, cloud computing, cloud functions, cloud storage, network services, cloud communications, middleware services, domain name services, security services, content distribution networks, as well as big data and artificial intelligence platforms. The electronic device 120 may include, for example, a computing system/server, such as a mainframe, an edge computing node, a computing device in a cloud environment, and the like. The electronic device 120 may provide a background service for the client 130, in the terminal device 110, that supports content presentation.

A communication connection may be established between the electronic device 120 and the terminal device 110. The communication connection may be established in a wired manner or a wireless manner. The communication connection may include, but are not limited to, Bluetooth connections, mobile network connections, universal serial bus connections, wireless fidelity connections, and the like, and the embodiments in the present disclosure are not limited in this regard. In the embodiments in the present disclosure, the electronic device 120 and the terminal device 110 may implement signaling interaction through the communication connection between the electronic device 120 and the terminal device 110.

It should be understood that the structures and functions of the various elements in the environment 100 are described for example purposes only and do not imply any limitation to the scope of the present disclosure.

### Training and Inference of Model

The process of training the target model will be described below with reference to FIG. 2. FIG. 2 illustrates a schematic diagram of constructing a training sequence 200 according to some embodiments in the present disclosure. In some embodiments, the target model may be constructed with a decoder only framework, and may be configured to predict, based on an existing token sequence, a next token in the sequence.

As shown in FIG. 2, during the process of constructing the training sequence 200, an appropriate training device (for example, the electronic device 120) may obtain a corresponding sequence template. Such sequence template may include a plurality of portions: a sequence portion corresponding to text content (e.g., a text token), a separator 220, a placeholder 230, and a sequence portion corresponding to speech content (e.g., a speech token).

During the process of constructing the training sequence 200, the electronic device 120 may obtain sample text and corresponding sample speech, and insert a corresponding sample text sequence 210 (for example, a set of text tokens) and a corresponding sample speech sequence (for example, a set of speech tokens) into the sequence template.

Further, for each training sequence 200 to be generated, the electronic device 120 may replace the placeholder 230 with the corresponding content. Under a first replacement strategy, the electronic device 120 may replace the placeholder 230 with preset content 230 (e.g., a sequence of all 0). Under a second replacement strategy, the electronic device 120 may process prompt speech 260 (also referred to as training speech content) with a speech encoder 250, so as to replace the placeholder 230 with a speech feature representation (e.g., speech embedding) of the prompt speech 260.

In some embodiments, to order to improve the diversity of the training sequence, the electronic device 120 may select, based on preset probabilistic information, a replacement strategy for generating each training sequence from the first replacement strategy and the second replacement strategy. As shown in FIG. 2, the electronic device 120 may randomly select, based on a preset probability (for example, probabilities P1 and P2, respectively), whether to use the preset content 230 or the speech feature representation to replace the placeholder 230.

Based on such manner, the embodiments in the present disclosure may improve the generalization capability of the model and avoid overfitting. In addition, as will be described below, this training method may also provide a larger innovation space for timbre customization, allowing flexible adjustment for model behavior according to different application requirements, and generating more natural and diversified speech content.

Further, based on such sequence design, during the inference process with the target model (i.e., generating the target speech content), the electronic device 120 construct a sequence with such sequence template accordingly.

In some embodiments, the electronic device 120 may construct a corresponding input sequence based on the two replacement strategies mentioned above to control the generation of the target speech content.

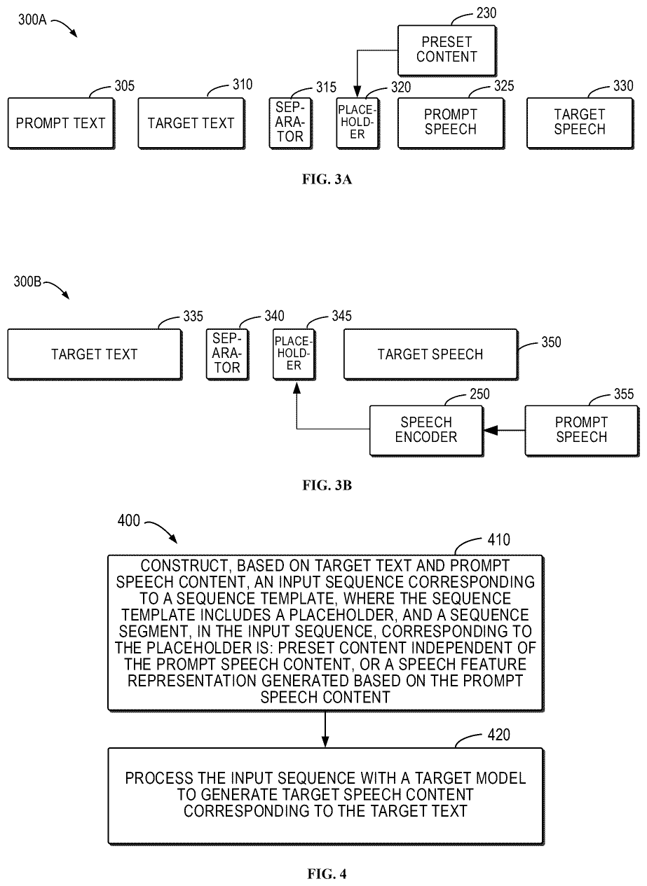

FIG. 3A illustrates a process of constructing an input sequence 300A according to some embodiments in the present disclosure. As shown in FIG. 3A, the input sequence 300A may correspond to the first replacement strategy, that is, the placeholder 320 may be replaced with the preset content 230, for example, a value of 0.

Further, in this case, the input sequence may further include a first portion 305 corresponding to the prompt text; a second portion 310 corresponding to a target text 310 for controlling the generation of the target speech content; a placeholder 315; and a third portion 325 corresponding to the prompt speech content. Such prompt text may correspond to prompting speech content.

Therefore, during the process of processing such an input sequence 300A, the target model may generate a corresponding speech token sequence 330 based on a next token prediction, so as to generate the target speech content.

In this case, the target model may determine at least one speech attribute of the generated target speech content based on the prompt speech content, for example, speech attributes such as timbre, prosody, rhythm, and the like. That is, such target speech content may have timbre, prosody, rhythm, or the like that is close to those of the prompt speech content.

FIG. 3B illustrates a process of constructing an input sequence 300B according to some embodiments of the present disclosure. As shown in FIG. 3B, the input sequence 300B may correspond to the second replacement strategy, that is, a placeholder 345 may be replaced with a speech feature representation generated with the speech encoder 250.

Unlike the process of constructing the input sequence 300A, as shown in FIG. 3B, the speech encoder 250 may process prompt speech content 355 to generate the speech feature representation. Such a speech feature representation may replace the placeholder 345 in the sequence template.

Additionally, the input sequence 300B does not include a sequence portion corresponding to the prompt speech content or the prompt text. As shown in FIG. 3B, the input sequence 300B may include only a fourth portion 335 corresponding to the target text 335, a separator 340, and the inserted speech feature representation.

Therefore, in the process of processing such input sequence 300B, the target model may generate a corresponding speech token sequence 350 based on the next token prediction, so as to generate the target speech content.

In some embodiments, the speech encoder 250 may be trained to extract the speech feature representation for characterizing a target speech attribute of the speech content. Such target speech attribute may include, for example, a timbre attribute.

In this case, the generated target speech content may correspond to the target speech attribute of the prompt speech content. For example, the target speech content may have a timbre attribute similar to or the same as the prompt speech content.

In some embodiments, the speech feature representation may characterize the target speech attribute of the prompt speech content, and the generated target speech content corresponding to the target speech attribute.

According to the method for speech generation by extracting the speech feature representation with the speech encoder, the embodiment in the present disclosure may support controlling the generation of the target speech content based on specific speech attributes of the prompt speech content, reducing the consumption of computing resource and improving the processing efficiency.

Based on the process described above, the embodiments in the present disclosure may enhance the adaptability and application range of timbre customization through a flexible switching mechanism, which may meet diversified timbre customization requirements.

### Example Processes

FIG. 4 illustrates a flowchart of an example process 400 of speech synthesis according to some embodiments of the present disclosure.

As shown in FIG. 4, in block 410, the electronic device 120 constructs, based on target text and prompt speech content, an input sequence corresponding to a sequence template, where the sequence template comprises a placeholder, and a sequence segment, in the input sequence, corresponding to the placeholder is: preset content independent of the prompt speech content, or a speech feature representation generated based on the prompt speech content.

At block 420, the electronic device 120 processes the input sequence with a target model to generate target speech content corresponding to the target text, where the target model is trained with a set of training sequences constructed based on the sequence template, the set of training sequences corresponds to a set of training speech content, and the set of training sequences is constructed by replacing the placeholder with the preset content or a training speech feature representation corresponding to respective training speech content.

In some embodiments, the process 400 further includes constructing the set of training sequences through: obtaining a sample text sequence and a corresponding sample speech sequence; determining a target replacement strategy for the placeholder in the sequence template; and generating, based on the target replacement strategy, a corresponding training sequence using the sample text sequence and the sample speech sequence.

In some embodiments, determining the target replacement strategy for the placeholder in the sequence template includes: determining, based on preset probabilistic information, the target replacement strategy from a first replacement strategy and a second replacement strategy, where the first replacement strategy indicates replacing the placeholder with the preset content, and the second replacement strategy indicates replacing the placeholder with the training speech feature representation.

In some embodiments, the training speech feature representation is generated through using a speech encoder to process the respective training speech content.

In some embodiments, the sequence segment, in the input sequence, corresponding to the placeholder is the preset content, and the input sequence further comprises: a first portion, corresponding to a prompt text corresponding to the prompt speech content; a second portion, corresponding to the target text; and a third portion, corresponding to the prompt speech content.

In some embodiments, at least one speech attribute of the target speech content is determined based on the prompt speech content.

In some embodiments, the sequence segment, in the input sequence, corresponding to the placeholder is the speech feature representation generated based on the prompt speech content, and the input sequence further comprises a fourth portion corresponding to the target text.

In some embodiments, the speech feature representation characterizes a target speech attribute of the prompt speech content, and the generated target speech content corresponds to the target speech attribute.

### Example Apparatus and Device

The embodiments in the present disclosure also provide a corresponding apparatus for performing the above method or process. FIG. 5 illustrates a schematic structural block diagram of a speech synthesis apparatus 500 according to some embodiments of the present disclosure. The apparatus 500 may be implemented or included in the electronic device 110. The various modules/components in the apparatus 500 may be implemented by hardware, software, firmware, or any combination thereof.

As shown in FIG. 5, the apparatus 500 includes an input sequence construction module 510 and a target speech content generation module 520. In some embodiments, the input sequence construction module 510 is configured to construct, based on target text and prompt speech content, an input sequence corresponding to a sequence template, where the sequence template comprises a placeholder, and a sequence segment, in the input sequence, corresponding to the placeholder is: preset content independent of the prompt speech content, or a speech feature representation generated based on the prompt speech content. The target speech content generation module 520 is configured to process the input sequence with a target model to generate target speech content corresponding to the target text. The target model is trained with a set of training sequences constructed based on the sequence template, the set of training sequences corresponds to a set of training speech content, and the set of training sequences is constructed by replacing the placeholder with the preset content or a training speech feature representation corresponding to respective training speech content.

In some embodiments, the apparatus 500 further includes a training module, configured to construct the set of training sequences through: obtaining a sample text sequence and a corresponding sample speech sequence; determining a target replacement strategy for the placeholder in the sequence template; and generating, based on the target replacement strategy, a corresponding training sequence using the sample text sequence and the sample speech sequence.

In some embodiments, the training module is further configured to determine, based on preset probabilistic information, the target replacement strategy from a first replacement strategy and a second replacement strategy, where the first replacement strategy indicates replacing the placeholder with the preset content, and the second replacement strategy indicates replacing the placeholder with the training speech feature representation.

In some embodiments, the training speech feature representation is generated through using a speech encoder to process the respective training speech content.

In some embodiments, the sequence segment, in the input sequence, corresponding to the placeholder is the preset content, and the input sequence further comprises: a first portion, corresponding to a prompt text corresponding to the prompt speech content; a second portion, corresponding to the target text; and a third portion, corresponding to the prompt speech content.

In some embodiments, at least one speech attribute of the target speech content is determined based on the prompt speech content.

In some embodiments, the sequence segment, in the input sequence, corresponding to the placeholder is the speech feature representation generated based on the prompt speech content, and the input sequence further comprises a fourth portion corresponding to the target text.

In some embodiments, the speech feature representation characterizes a target speech attribute of the prompt speech content, and the generated target speech content corresponds to the target speech attribute.

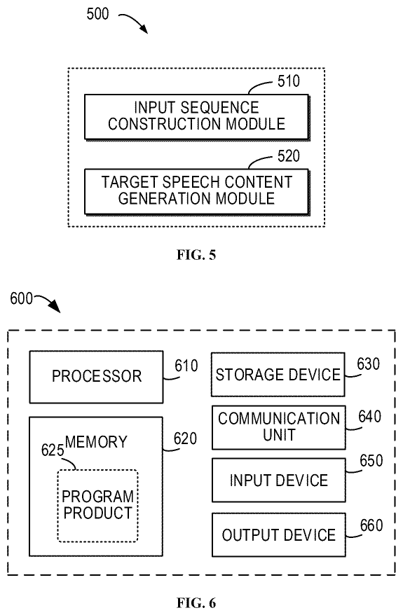

FIG. 6 illustrates a block diagram of an electronic device/server 600 in which one or more embodiments in the present disclosure may be implemented. For example, the electronic device/server 600 may be configured to implement the electronic device 120 shown in FIG. 1. It would be appreciated that the electronic device/server 600 illustrated in FIG. 6 is merely example and should not constitute any limitation on the functionality and scope of the embodiments described herein.

As shown in FIG. 6, the electronic device 600 is in the form of a general-purpose electronic device. Components of the electronic device 600 may include, but are not limited to, one or more processors or processors 610, a memory 620, a storage device 630, one or more communication units 640, one or more input devices 660, and one or more output devices 660. The processor 610 may be an actual or virtual processor capable of performing various processes according to a program stored in the memory 620. In a multiprocessor system, a plurality of processors execute computer-executable instructions in parallel to improve the parallel processing capabilities of electronic device 600.

The electronic device 600 typically includes a variety of computer storage media. Such media may be any available media that are accessible to the electronic device 600, including, but not limited to, volatile and non-volatile media, removable and non-removable media. The memory 620 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium, such as a flash drive, magnetic disk, or any other medium that can be used to store information and/or data and that can be accessed within the electronic device 600.

The electronic device 600 may further include an additional removable/non-removable, volatile/non-volatile storage medium. Although not shown in FIG. 6, a disk drive for reading from or writing to a removable, non-volatile magnetic disk (e.g., a “floppy disk”) or an optical disk drive for reading from or writing to a removable, non-volatile optical disk may be provided. In these cases, each drive may be connected to a bus (not shown) by one or more data media interfaces. The memory 620 may include a computer program product 626 having one or more program modules configured to execute various methods or actions of the various embodiments in the present disclosure.

The communication unit 640 is configured to communicate with other electronic devices through a communication medium. Additionally, the functionality of components of the electronic device 600 may be implemented by a single computing cluster or multiple computing machines capable of communicating through a communication connection. Thus, the electronic device 600 may operate in a networked environment using a logical connection with one or more other servers, network personal computers (PCs), or another network node.

The input device 660 may be one or more input devices such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed. The external device, such as a storage device, a display device, etc., communicates with one or more devices that enable users to interact with the electronic device 600, or communicates with any device (e.g., a network card, a modem, etc.) that enables the electronic device 600 to communicate with one or more other electronic devices. Such communication may be performed via an input/output (I/O) interface (not shown).

According to example implementations in the present disclosure, a computer-readable storage medium having computer-executable instructions stored thereon is provided. The computer-executable instructions are executed by a processor to implement the method described above. According to example implementations in the present disclosure, a computer program product is further provided. The computer program product is tangibly stored on a non-transitory computer-readable medium and includes computer-executable instructions. The computer-executable instructions are executed by a processor to implement the method described above.

Various aspects in the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processor of a general-purpose computer, special computer, or other programmable data processing apparatus to produce a machine that generates an apparatus to implement the functions/acts specified in one or more blocks in the flowchart and/or the block diagram when these instructions are executed through the processors of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in one or more blocks in the flowchart and/or block diagram(s).

The computer-readable program instructions may be loaded onto a computer, a programmable data processing apparatus, or a further device, such that a series of operational steps can be performed on the computer, programmable data processing apparatus, or the further device to produce a computer-implemented process. As such, the instructions executed on the computer, programmable data processing apparatus, or the further device implement the functions/acts specified in the one or more blocks in the flowchart and/or block diagram(s).

The flowchart and block diagrams in the drawings show the possible architecture, functions and operations of the system, the method, and the computer program product implemented according to various implementations in the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations in the present disclosure have been described above. The above description is example, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

What is claimed is:

1. A speech synthesis method, comprising:
constructing, based on target text and prompt speech content, an input sequence corresponding to a sequence template, wherein the sequence template comprises a placeholder, and a sequence segment, in the input sequence, corresponding to the placeholder is: preset content independent of the prompt speech content, or a speech feature representation generated based on the prompt speech content; and
processing the input sequence with a target model to generate target speech content corresponding to the target text,
wherein the target model is trained with a set of training sequences constructed based on the sequence template, the set of training sequences corresponds to a set of training speech content, and the set of training sequences is constructed by replacing the placeholder with the preset content or a training speech feature representation corresponding to respective training speech content.

2. The method of claim 1, further comprising constructing the set of training sequences through:
obtaining a sample text sequence and a corresponding sample speech sequence;
determining a target replacement strategy for the placeholder in the sequence template; and
generating, based on the target replacement strategy, a corresponding training sequence using the sample text sequence and the sample speech sequence.

3. The method of claim 2, wherein determining the target replacement strategy for the placeholder in the sequence template comprises:
determining, based on preset probabilistic information, the target replacement strategy from a first replacement strategy and a second replacement strategy, wherein the first replacement strategy indicates replacing the placeholder with the preset content, and the second replacement strategy indicates replacing the placeholder with the training speech feature representation.

4. The method of claim 1, wherein the training speech feature representation is generated through using a speech encoder to process the respective training speech content.

5. The method of claim 1, wherein the sequence segment, in the input sequence, corresponding to the placeholder is the preset content, and the input sequence further comprises:
a first portion, corresponding to a prompt text corresponding to the prompt speech content;
a second portion, corresponding to the target text; and
a third portion, corresponding to the prompt speech content.

6. The method of claim 5, wherein at least one speech attribute of the target speech content is determined based on the prompt speech content.

7. The method of claim 1, wherein the sequence segment, in the input sequence, corresponding to the placeholder is the speech feature representation generated based on the prompt speech content, and the input sequence further comprises a fourth portion corresponding to the target text.

8. The method of claim 7, wherein the speech feature representation characterizes a target speech attribute of the prompt speech content, and the generated target speech content corresponds to the target speech attribute.

9. An electronic device, comprising:
at least one processor; and
at least one memory coupled to the at least one processor and storing instructions for execution by the at least one processor, the instructions, when executed by the at least one processor, causing the electronic device to perform operations for speech synthesis comprising:
constructing, based on target text and prompt speech content, an input sequence corresponding to a sequence template, wherein the sequence template comprises a placeholder, and a sequence segment, in the input sequence, corresponding to the placeholder is: preset content independent of the prompt speech content, or a speech feature representation generated based on the prompt speech content; and
processing the input sequence with a target model to generate target speech content corresponding to the target text,
wherein the target model is trained with a set of training sequences constructed based on the sequence template, the set of training sequences corresponds to a set of training speech content, and the set of training sequences is constructed by replacing the placeholder with the preset content or a training speech feature representation corresponding to respective training speech content.

10. The electronic device of claim 9, wherein the operations further comprise constructing the set of training sequences through:
obtaining a sample text sequence and a corresponding sample speech sequence;
determining a target replacement strategy for the placeholder in the sequence template; and
generating, based on the target replacement strategy, a corresponding training sequence using the sample text sequence and the sample speech sequence.

11. The electronic device of claim 10, wherein determining the target replacement strategy for the placeholder in the sequence template comprises:
determining, based on preset probabilistic information, the target replacement strategy from a first replacement strategy and a second replacement strategy, wherein the first replacement strategy indicates replacing the placeholder with the preset content, and the second replacement strategy indicates replacing the placeholder with the training speech feature representation.

12. The electronic device of claim 9, wherein the training speech feature representation is generated through using a speech encoder to process the respective training speech content.

13. The electronic device of claim 9, wherein the sequence segment, in the input sequence, corresponding to the placeholder is the preset content, and the input sequence further comprises:
a first portion, corresponding to a prompt text corresponding to the prompt speech content;
a second portion, corresponding to the target text; and
a third portion, corresponding to the prompt speech content.

14. The electronic device of claim 13, wherein at least one speech attribute of the target speech content is determined based on the prompt speech content.

15. The electronic device of claim 9, wherein the sequence segment, in the input sequence, corresponding to the placeholder is the speech feature representation generated based on the prompt speech content, and the input sequence further comprises a fourth portion corresponding to the target text.

16. The electronic device of claim 15, wherein the speech feature representation characterizes a target speech attribute of the prompt speech content, and the generated target speech content corresponds to the target speech attribute.

17. A non-transitory computer-readable storage medium having a computer program stored thereon, wherein the computer program is executable by a processor to perform operations for speech synthesis, comprising:
constructing, based on target text and prompt speech content, an input sequence corresponding to a sequence template, wherein the sequence template comprises a placeholder, and a sequence segment, in the input sequence, corresponding to the placeholder is: preset content independent of the prompt speech content, or a speech feature representation generated based on the prompt speech content; and
processing the input sequence with a target model to generate target speech content corresponding to the target text,
wherein the target model is trained with a set of training sequences constructed based on the sequence template, the set of training sequences corresponds to a set of training speech content, and the set of training sequences is constructed by replacing the placeholder with the preset content or a training speech feature representation corresponding to respective training speech content.

18. The non-transitory computer-readable storage medium of claim 17, wherein the operations further comprise constructing the set of training sequences through:
obtaining a sample text sequence and a corresponding sample speech sequence;
determining a target replacement strategy for the placeholder in the sequence template; and
generating, based on the target replacement strategy, a corresponding training sequence using the sample text sequence and the sample speech sequence.

19. The non-transitory computer-readable storage medium of claim 18, wherein determining the target replacement strategy for the placeholder in the sequence template comprises:
determining, based on preset probabilistic information, the target replacement strategy from a first replacement strategy and a second replacement strategy, wherein the first replacement strategy indicates replacing the placeholder with the preset content, and the second replacement strategy indicates replacing the placeholder with the training speech feature representation.

20. The non-transitory computer-readable storage medium of claim 17, wherein the training speech feature representation is generated through using a speech encoder to process the respective training speech content.
